(19) United States
(12) Patent Application Publication
(10) Pub. No.: US 2009/0194992 A1
(43) Pub. Date: Aug. 6, 2009

(54) PIPE COMPENSATION SYSTEM

(76) Inventors: Zbigniew Bochenek, Burbank, IL (US); Bruce M. Platusich, Lewisburg, PA (US); James R. Richter, Lincolnshire, IL (US); James David Clauss, Frankfort, IL (US)

Correspondence Address: GREER, BURNS & CRAIN, 300 S WACKER DR, 25TH FLOOR, CHICAGO, IL, 60606, US

(21) Appl. No.: 12/025,952

(22) Filed: Feb. 5, 2008

(51) Int. Cl. F16L 51/00; F16L 3/00

(52) U.S. Cl. 285/61; 248/49

(57) ABSTRACT

A compensation system for use with a divided pipe having a pair of open ends and being supported at first and second spaced apart points which are moveable relative to one another. A loop member attaches to the open ends of the pipe and is supported by a support system. The loop member includes a bend causing the loop member to extend away from the pipe, the loop member being flexible enough to accommodate a movement between the open ends of the pipe. The support system includes a flexible support having a first end secured to move with the first point and a second end secured move with the second point. Also, a support connection is provided at the loop member for engagement by the flexible support between the two ends to permit movement of the loop member relative to the pipe, the support connection permitting movement of the flexible support relative to the tubing.

### BACKGROUND OF THE INVENTION

The present invention relates to devices for absorbing movement in runs or lines of pipe.

In conventional plumbing installations, there is the inevitable problem of movement of pipes in the installation. Movement of the pipes may be caused by expansion, contraction, building movement, earthquake, explosion, or other factors. Such movement often causes the pipes to leak or break apart.

Flexible pipe loops have been employed to compensate for and absorb pipe movements. For example, U.S. Pat. No. 5,195,784 to Richter, U.S. Pat. No. 5,803,506 to Argersinger and U.S. Pat. No. 7,195,284 to Garton, et al. disclose such flexible pipe loops.

### SUMMARY OF THE INVENTION

A compensation system is provided for use with a pipe extending along a longitudinal axis and divided along its length to form a pair of open ends. The pipe is supported at first and second spaced apart points, which points are subject to movement relative to one another. The system includes a loop member attached to the pipe at the open ends and a support system for the loop member.

The loop member includes a first and second connector end each configured to mate with one of the open ends of the divided pipe, and a length of tubing extending between the first and second connector ends having at least one bend therein causing the tubing to extend away from the longitudinal axis of the pipe, the tubing being sufficiently flexible so as to accommodate a movement between the open ends of the pipe both axially and laterally, sufficient to relieve stress in the pipeline. In some installations this could be as little as ⅛^{th} of an inch, while in other installations it may be greater than a diameter of the pipe.

The support system includes a flexible support having a first end and a second end. The flexible support first end is secured relative to the first point such that it will move with the first point and the flexible support second end is secured relative to the second point such that it will move with the second point, when the first and second points move relative to one another. The support system further includes a support connection provided at the length of tubing for engagement by the flexible support between the two ends to permit movement of the tubing relative to the pipe, the support connection permitting movement of the flexible support relative to the tubing.

### BRIEF DESCRIPTION OF THE DRAWINGS

FIG. 1 is a side elevational view of a first embodiment of a pipe compensation system.

FIG. 2 is perspective view of a second embodiment of a pipe compensation system.

FIG. 3 is side elevational view of a third embodiment of a pipe compensation system.

FIG. 4 is a perspective view of a fourth embodiment of a pipe compensation system.

FIG. 5 is a perspective view of a fifth embodiment of a pipe compensation system.

### DETAILED DESCRIPTION OF THE EMBODIMENTS

In FIG. 1 a first embodiment of a compensation system 20 is illustrated for use with a pipe 22 extending along a longitudinal axis 24 and divided along its length to form a pair of open ends 26, 28. The open ends 26, 28 may be arranged at any position along a length of pipe, including at a corner junction, or at a point where the pipe 22 protrudes from an opening in a wall. The compensation system 20 may also be connected directly to another component of a pipeline, such as a pump, elbow, wye, or other component normally associated with pipelines. The pipe 22 may be part of a pipeline within a single building or structure, or may extend between two or more structures. The pipe 22 is supported at first 30 and second 32 spaced apart points, which points are subject to movement relative to one another. The first and second points 30, 32 may include pipe guides or pipe hangers 31, 33 which are secured to structures 35a, 35b. The structures 35a, 35b may be part of a single structure or building, or may be two separate structures, buildings or parts of buildings. In the case of buildings constructed to accommodate seismic events or thermal expansion and contraction, the buildings may be constructed such that portions of the building are movable relative to other portions of the building, with a space, sometimes referred to as a seismic or thermal separation located between the two parts. The two points 30, 32 may be located on opposite sides of such a separation from one another, and therefore may be subject to movement relative to one another.

The system 20 includes a loop member 34 attached to the pipe 22 at the open ends 26, 28 and a support system 36 for the loop member 34.

The loop member 34 absorbs movement in the pipe 22 between the two fixed points 30, 32. This movement could be in a longitudinal or lateral direction relative to the pipe 22. The loop member 34 includes a first 38 and second 40 connector end each configured to mate with one of the open ends 26, 28 of the divided pipe 22. Various types of connections, such as threaded connections, welded or soldered connections, flanged connections, compression fittings, and similar well known pipe fittings may be provided for securing the loop member 34 to the pipe 22. A length of flexible tubing 50 extends between the first and second connector ends 38, 40. The tubing 50 has at least one bend 52 therein causing the tubing to extend away from the longitudinal axis 24 of the pipe 22. In the embodiment shown in FIG. 1, the loop member 34 extends vertically away from the pipe axis 24. The tubing 50 is sufficiently flexible so as to accommodate a movement between the open ends 26, 28 of the pipe 22 both axially and laterally, sufficient to relieve stress in the pipeline. In some installations this could be as little as ⅛^{th} of an inch, while in other installations it may be greater than a diameter of the pipe.

In the embodiment shown in FIG. 1, the loop member 34 includes a pair of elbow connectors 54 each having a first connector end 56 configured to mate with one of the open ends 26, 28 of the divided pipe 22 and a 90 degree bend 58 between the connector end 56 and an opposite second end 60. The loop member 34 also includes a return member 62 having a pair of open ends 64, 66 separated by a 180 degree bend. In other embodiments, shown in other figures, the elbow connectors 54 may have a 45 degree bend, with the return member 62 having a 90 degree bend. In still other embodiments, the elbow connectors 54 may have a 30 degree bend, and the return member a 60 degree bend. Many other arrangements may be provided within the scope of the present invention, such that the loop member is arranged at an angle relative to the axis 24 of the pipe 22, rather than being in alignment with the pipe.

Further, the loop member 34 includes a pair of flexible tube members 68 each having a first end 70 connected to one of the second ends 60 of the elbow connectors and a second end 72 connected to one of the ends 64, 66 of the return member 62. The flexible tube members 68 may each comprise an inner corrugated hose and an outer braided cover, or may comprise other types of flexible tubes, such as rubber or plastic tubes or corrugated hose without an outer braided cover. In some installations, particularly with smaller diameter pipes, a flexible metal tube may be used.

The support system 36 provides support for the loop member 34 and also accommodates movement of the loop member 34 when there is movement between the two fixed points 30, 32. In prior support arrangements, such as disclosed in Richter, the support is connected to a single support point, which will be fixed relative to one or the other of the fixed points 30, 32 when there is movement between those points. It has been unexpectedly discovered that providing a support system 36 which is secured to two points, each one fixed relative to one of the fixed points 30, 32, and allowing for a movable connection between the support system 36 and the loop member 34, surprisingly allows for a much better distributed distortion of the loop member 34 when there is movement between the two fixed points 30, 32. As in the embodiment of FIG. 1, this means that the flexing of the two flexible tubes 68 will be generally the same, rather than having the return member 62 pulled to one side or the other, resulting in greater flexing of one of the tubes than the other.

To provide such a support system 36, there is provided a flexible support 74, which in the embodiment of FIG. 1 is shown to be a flexible cable, having a first end 76 and a second end 78. The flexible support first end 76 is secured relative to the first point 30 such that it will move with the first point and the flexible support second end 78 is secured relative to the second point 32 such that it will move with the second point, when the first and second points move relative to one another. The first end 76 and second end 78 may be positioned at the same or different elevations, and may be in or out of alignment with the axis 24 of the pipe 22. In the example shown in FIG. 1, the flexible support first end 76 is secured to the pipe hanger 31 which includes the first pipe support point 30. Also, the flexible support second end 78 is secured to the pipe hanger 33 which includes the second pipe support point 32. The support system 36 further includes a support connection 80 provided at the length of tubing 50 for engagement by the flexible support 74 between the two connector ends 38, 40 to permit movement of the tubing relative to the pipe 22. As shown in the embodiment of FIG. 1, the support connection 80 may be provided at an apex 79 of the return member 62. The support connection 80 permits movement of the flexible support 74 relative to the tubing 50. In the embodiment of FIG. 1, the support connection 80 comprises a pulley which the cable of the flexible support 74 engages, the pulley allowing the flexible support to move relative to the pulley and the remainder of the tubing 50.

As shown in FIG. 1, the flexible support 74 is secured at its first and second ends 76, 78 such that an angle A of the flexible support between the support connection 80 and either of the first and second ends relative to horizontal or vertical is approximately 45°. It has been unexpectedly discovered that by having the angle A be approximately 45°, the forces acting on the two flexible tubes 68 of the loop member 34 are surprisingly equalized or more equalized during most movements of the fixed points 30, 32 relative to one another. In some situations and mounting arrangements, the precise angle of 45° cannot be achieved for both angles, however, this angle does provide a more equalized force on the two legs of the flexible support 74.

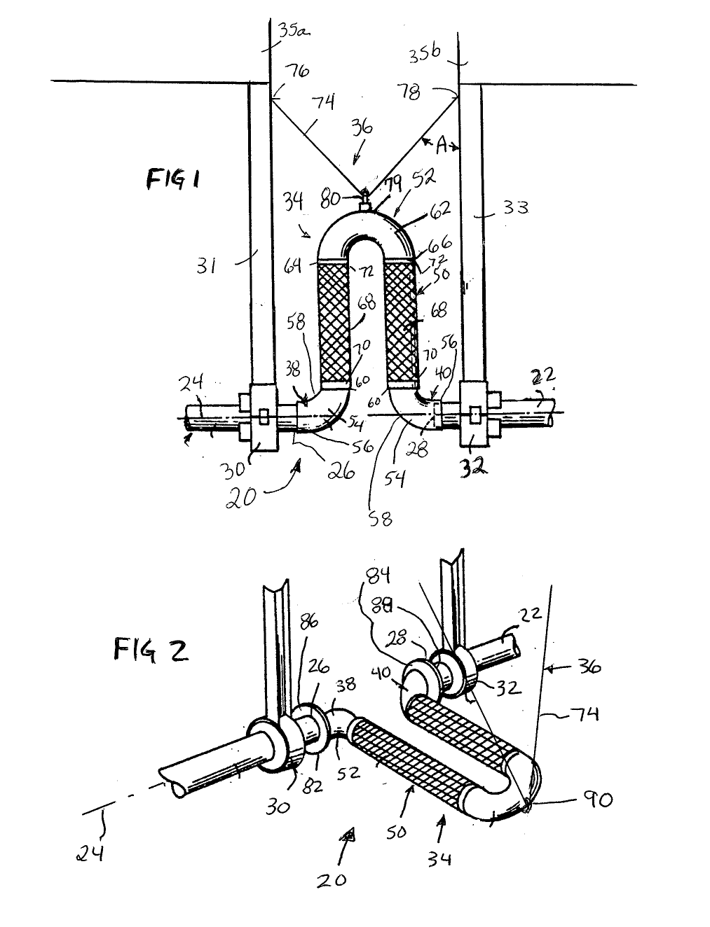

In FIG. 2 a second embodiment of the compensation system 20 is illustrated for use with the pipe 22. Again, the pipe 22 is supported at the first 30 and second 32 spaced apart points, which points are subject to movement relative to one another.

The system 20 includes the loop member 34 attached to the pipe 22 at the open ends 26, 28 and the support system 36 for the loop member 34.

The loop member 34 includes the first 38 and second 40 connector ends each configured to mate with one of the open ends 26, 28 of the divided pipe 22. In this embodiment, the connector ends 38, 40 are provided with flanges 82, 84 which mate with flanges 86, 88 at the open ends 26, 28 of the pipe 22. The length of tubing 50 extends between the first and second connector ends 38, 40. The tubing 50 has at least one bend 52 therein causing the tubing to extend away from the longitudinal axis 24 of the pipe 22. In the embodiment shown in FIG. 2, the loop member 34 extends horizontally away from the pipe axis 24. The tubing 50 is sufficiently flexible so as to accommodate a movement between the open ends 26, 28 of the pipe 22 both axially and laterally, sufficient to relieve stress in the pipeline. In some installations this could be as little as ⅛^{th} of an inch, while in other installations it may be greater than a diameter of the pipe.

The support system 36 includes the flexible support 74, which in the embodiment of FIG. 2 is shown to be a flexible cable. The support system 36 further includes a support connection 90 provided at the length of tubing 50 for engagement by the flexible support 74 between the two connector ends 38, 40 to permit movement of the tubing relative to the pipe 22. The support connection 90 permits movement of the flexible support 74 relative to the tubing 50. In the embodiment of FIG. 2, the support connection 90 comprises a bracket which the cable of the flexible support 74 slidingly engages, the sliding engagement between the flexible support and the bracket allowing the flexible support to move relative to the bracket and the remainder of the tubing 50.

Most other aspects of the embodiment of FIG. 2 are the same or similar to the arrangement shown in FIG. 1. For example, the ends of the flexible support 74 could be attached relative to the support connection 90 so as to provide an angle of 45° for the two legs of the flexible support.

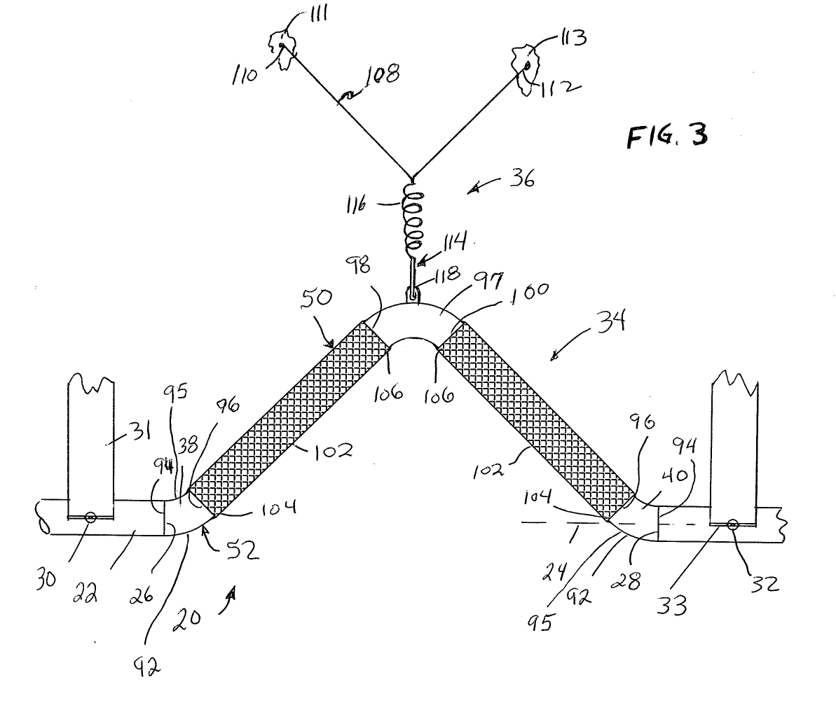

In FIG. 3 a third embodiment of the compensation system 20 is illustrated for use with the pipe 22 extending along the longitudinal axis 24 and divided along its length to form the pair of open ends 26, 28. The pipe 22 is supported at the first 30 and second 32 spaced apart points, which points are subject to movement relative to one another. The first and second points 30, 32 may comprise pipe hangers 31, 33 which are secured to structures (not shown). The two points 30, 32 may be located on opposite sides of a separation from one another, and therefore may be subject to movement relative to one another.

The system 20 includes the loop member 34 attached to the pipe 22 at the open ends 26, 28 and the support system 36 for the loop member 34.

The loop member 34 includes the first 38 and second 40 connector ends each configured to mate with one of the open ends 26, 28 of the divided pipe 22. The length of tubing 50 extends between the first and second connector ends 38, 40. The tubing 50 has at least one bend 52 therein causing the tubing to extend away from the longitudinal axis 24 of the pipe 22. In the embodiment shown in FIG. 3, the loop member 34 extends vertically away from the pipe axis 24, although it could extend horizontally, or at any other angle. The tubing 50 is sufficiently flexible so as to accommodate a movement between the open ends 26, 28 of the pipe 22 both axially and laterally, sufficient to relieve stress in the pipeline. In some installations this could be as little as ⅛^{th} of an inch, while in other installations it may be greater than a diameter of the pipe.

In the embodiment shown in FIG. 3, the loop member 34 includes a pair of elbow connectors 92 each having a first connector end 94 configured to mate with one of the open ends 26, 28 of the divided pipe 22 and a 45 degree bend 95 between the connector end 94 and an opposite second end 96. The loop member 34 also includes a return member 97 having a pair of open ends 98, 100 separated by a 90 degree bend. Further, the loop member 34 includes a pair of flexible tube members 102 each having a first end 104 connected to one of the second ends 96 of the elbow connectors and a second end 106 connected to one of the ends 98, 100 of the return member 97. The flexible tube members 102 may each comprise an inner corrugated hose and an outer braided cover, or may comprise other types of flexible tubes, such as rubber or plastic tubes or corrugated hose without an outer braided cover. In some installations, particularly with smaller diameter pipes, a flexible metal tube may be used.

The support system 36 includes a flexible support 108, which in the embodiment of FIG. 3 may be a flexible cable or rigid rods, having a first end 110 and a second end 112. The flexible support first end 110 is secured relative to the first point 30 such that it will move with the first point when the first and second points move relative to one another. The flexible support second end 112 is secured relative to the second point 32 such that it will move with the second point when the first and second points move relative to one another. In the embodiment shown in FIG. 3, the flexible support first end 110 is secured to a structure 111 which moves with a support structure for the first point 30. The flexible support second end 112 is secured to a structure which moves with the second pipe support point 32. The support system 36 further includes a support connection 114 provided at the length of tubing 50 for engagement by the flexible support 108 between the two connector ends 94 to permit movement of the tubing relative to the pipe 22. As shown in the embodiment of FIG. 3, the support connection 114 may be provided at the apex of the return member 97. The support connection 114 permits movement of the flexible support 108 relative to the tubing 50. In the embodiment of FIG. 3, the support connection 114 comprises a spring 116 which the flexible support 108 engages at one end and which may be attached via a pivotable connection 118 at an opposite end. The pivoting spring 116 allows the flexible support 108 to move relative to the tubing 50, hence rending it flexible in the event that the flexible support 108 is comprised of rigid rods. The flexible support 108 may also be able to slide relative to its connection to the spring 116.

Most other aspects of the embodiment of FIG. 3 are the same or similar to the arrangement shown in FIG. 1. For example, the ends 110, 112 of the flexible support 108 could be attached relative to the support connection 114 such that an angle of 45° is achieved for the two legs of the flexible support 108.

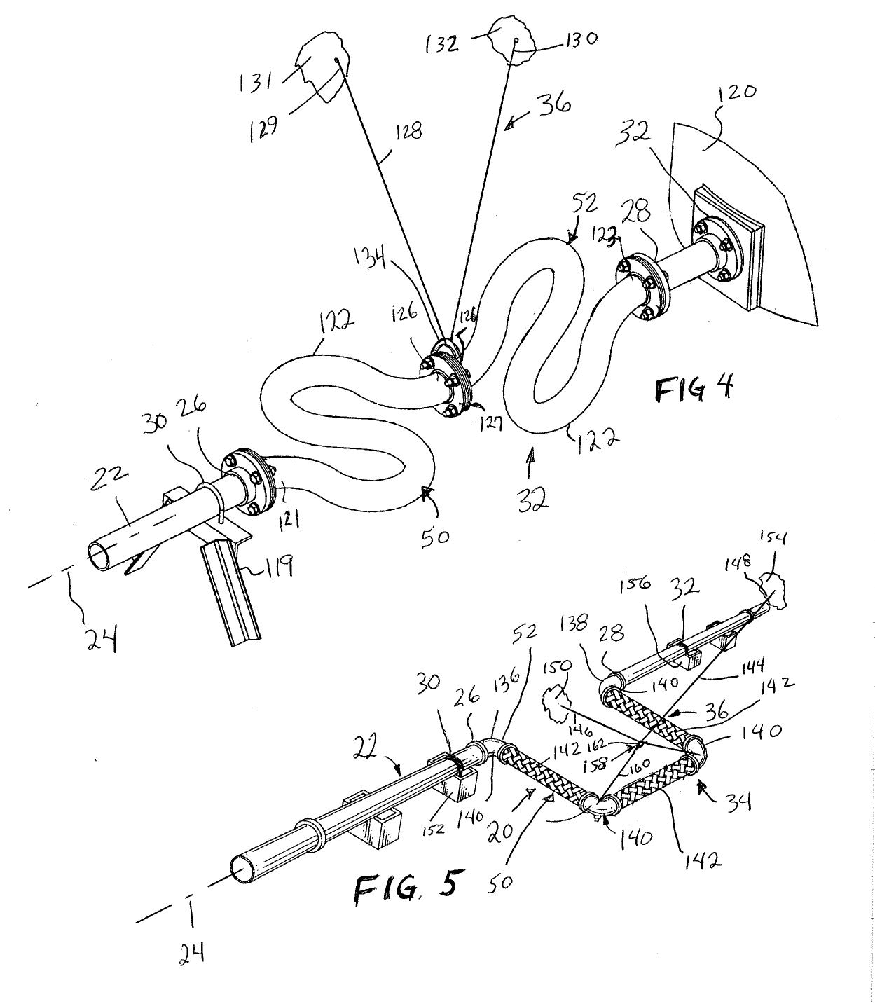

In FIG. 4 a fourth embodiment of the compensation system 20 is illustrated for use with the pipe 22 extending along the longitudinal axis 24 and divided along its length to form the pair of open ends 26, 28. The pipe 22 is supported at first 30 and second 32 spaced apart points, which points are subject to movement relative to one another. The first point 30 is shown to be a support of the pipe 22 from a structure 119 below the pipe. The second point 32 is shown to be a support directly attached to a structure comprising a wall 120. The structures 119, 120 may be part of a single structure or building, or may be two separate structures, buildings or parts of buildings. The two points 119, 120 may be located on opposite sides of a thermal or seismic separation from one another, and therefore may be subject to movement relative to one another.

The system 20 includes the loop member 34 attached to the pipe 22 at the open ends 26, 28 and a support system 36 for the loop member 34.

The loop member 34 includes a first 121 and second 123 connector end each configured to mate with one of the open ends 26, 28 of the divided pipe 22. A length of tubing 50 extends between the first and second connector ends 121, 123. The tubing 50 has at least one bend 52 therein causing the tubing to extend away from the longitudinal axis 24 of the pipe 22. In the embodiment shown in FIG. 4, the loop member 34 extends both vertically and horizontally away from the pipe axis 24. The tubing 50 is sufficiently flexible so as to accommodate a movement between the open ends 26, 28 of the pipe 22 both axially and laterally, sufficient to relieve stress in the pipeline. In some installations this could be as little as ⅛^{th} of an inch, while in other installations it may be greater than a diameter of the pipe.

In the embodiment shown in FIG. 4, the loop member 34 includes a pair of multiply curved tubes 122, one having the first connector end 121, and the other having the second connector end 123, configured to mate with one of the open ends 26, 28 of the divided pipe 22 and an S-shape between the connector end 124 and an opposite second end 126. The two second ends 126 are joined to each other via a flanged connection 127, but any other type of plumbing connection could be provided. Further, a single one of the curved tubes 122 could be positioned between the open ends 26, 28 of the pipe, rather than the two tubes illustrated.

The support system 36 includes a flexible support 128, which in the embodiment of FIG. 4 is shown to be a flexible cable, having a first end 129 and a second end 130. The flexible support first end 129 is secured relative to the first point 30 such that it will move with the first point and the flexible support second end 130 is secured relative to the second point 32 such that it will move with the second point, when the first and second points move relative to one another. In the example shown in FIG. 4, the flexible support first end 129 is secured to a structure 131 which moves with the support structure 119 for the first point 30. The flexible support second end 130 is secured to a structure 132 which moves with the structure 120 for the second pipe support point 32. The support system 36 further includes a support connection 134 provided at the length of tubing 50 for engagement by the flexible support 128 between the two connector ends 1212, 123 to permit movement of the tubing 50 relative to the pipe 22. The support connection 134 permits movement of the flexible support 128 relative to the tubing 50. In the embodiment of FIG. 4, the support connection 134 comprises a loop which the cable of the flexible support 128 slidingly engages, the sliding engagement allowing the flexible support to move relative to the loop and the remainder of the tubing 50.

Most other aspects of the embodiment of FIG. 4 are the same or similar to the arrangement shown in FIG. 1. For example, the ends 129, 130 of the flexible support 128 could be attached relative to the support connection 134 such that an angle of 45° is achieved for the two legs of the flexible support 128.

In FIG. 5 a fifth embodiment of the compensation system 20 is illustrated for use with the pipe 22 extending along the longitudinal axis 24 and divided along its length to form the pair of open ends 26, 28. The pipe 22 is supported at first 30 and second 32 spaced apart points, which points are subject to movement relative to one another.

The system 20 includes the loop member 34 attached to the pipe 22 at the open ends 26, 28 and the support system 36 for the loop member 34.

The loop member 34 includes a first 136 and second 138 connector end each configured to mate with one of the open ends 26, 28 of the divided pipe 22. The length of tubing 50 extends between the first and second connector ends 136, 138. The tubing 50 has at least one bend 52 therein causing the tubing to extend away from the longitudinal axis 24 of the pipe 22. In the embodiment shown in FIG. 5, the loop member 34 extends horizontally away from the pipe axis 24, although it could extend in other directions as well. The tubing 50 is sufficiently flexible so as to accommodate a movement between the open ends 26, 28 of the pipe 22 both axially and laterally, sufficient to relieve stress in the pipeline. In some installations this could be as little as ⅛^{th} of an inch, while in other installations it may be greater than a diameter of the pipe.

In the embodiment shown in FIG. 5, the loop member 34 includes four elbow connectors 140 each having a 90 degree bend therein. The loop member 34 also includes three flexible tube members 142 each connected to two of the elbow connectors 140. The flexible tube members 142 may each comprise an inner corrugated hose and an outer braided cover, or may comprise other types of flexible tubes, such as rubber or plastic tubes or corrugated hose without an outer braided cover. In some installations, particularly with smaller diameter pipes, a flexible metal tube may be used.

The support system 36 includes a flexible support 144, which in the embodiment of FIG. 5 is shown to be a flexible cable, having a first end 146 and a second end 148. In the example shown in FIG. 5, the flexible support first end 146 is secured to a structure 154 which moves with a support structure 156 for the first point 30. The flexible support second end 148 is secured relative to a structure 154 which moves with a support structure 156 for the second point 32. The support system 36 further includes a support connection 158 provided at the length of tubing 50 for engagement by the flexible support 144 between the two connector ends 136, 138 to permit movement of the tubing relative to the pipe 22. The support connection 158 permits movement of the flexible support 144 relative to the tubing 50. In the embodiment of FIG. 5, the support connection 158 comprises cables or rods 160 leading from two outermost connectors 140 to a ring 162 which the cable of the flexible support 144 passes through, the ring allowing the flexible support to slide relative to the ring and the remainder of the tubing 50.

Most other aspects of the embodiment of FIG. 5 are the same or similar to the arrangement shown in FIG. 1. For example, the ends 146, 148 of the flexible support 144 could be attached relative to the support connection 158 such that an angle of 45° is achieved for the two legs of the flexible support 144.

As is apparent from the foregoing specification, the invention is susceptible of being embodied with various alterations and modifications which may differ particularly from those that have been described in the preceding specification and description. It should be understood that I wish to embody within the scope of the patent warranted hereon all such modifications as reasonably and properly come within the scope of my contribution to the art.

I claim as my invention:

1. A compensation system for use with a pipe extending along a longitudinal axis and divided along its length to form a pair of open ends, the pipe being supported by at least one structure at first and second spaced apart points which points are subject to movement relative to one another, comprising:
a loop member attached to the pipe at the open ends and a support system for the loop member;
the loop member comprising:
a plurality of elbow connectors each having a first connector end configured to mate with one of the open ends of the divided pipe and a bend between the connector end and an opposite second end,
a return member having a pair of open ends,
a plurality of flexible tube members each having a first end connected to one of the second ends of the elbow connectors and a second end connected to one of the ends of the return member,
the support system comprising:
a flexible support having a first end and a second end, the flexible support first end being secured relative to the at least one structure such that it will move with the first point and the flexible support second end being secured relative to the at least one structure such that it will move with the second point, when the first and second points move relative to one another, and
a support connection provided at the return member for engagement by the flexible support between the two ends to permit movement of the return member relative to the pipe, the support connection permitting movement of the flexible support relative to the support connection.

2. The compensation system according to claim 1, wherein the first and second spaced apart points are located in two separate structures.

3. The compensation system according to claim 1, wherein the elbow connectors each have a 90 degree bend between the connector end and the opposite second end.

4. The compensation system according to claim 1, wherein the flexible tube members each comprise an inner corrugated hose and an outer braided cover.

5. The compensation system according to claim 1, wherein the return member has the pair of open ends separated by a 180 degree bend.

6. The compensation system according to claim 1, wherein the return member has the pair of open ends separated by a 90 degree bend.

7. The compensation system according to claim 1, wherein the cable first end is secured to the structure which includes the first pipe support point.

8. The compensation system according to claim 1, wherein the cable second end is secured to the structure which includes the second pipe support point.

9. The compensation system according to claim 1, wherein the support connection comprises a pulley secured to the return member.

10. The compensation system according to claim 1, wherein the support connection comprises a support bracket formed on the return member providing a sliding support for the cable.

11. The compensation system according to claim 1, wherein the support connection comprises a spring interposed between the cable and the return member.

12. The compensation system according to claim 1, wherein the support connection is provided at an apex of the return member.

13. The compensation system according to claim 1, wherein the first pipe support point is separated from the second pipe support point by a predetermined distance and the flexible support is secured at its first and second ends to the at least one structure at a vertical distance above the support connection at the return member so as to provide an angle of approximately 45° between the flexible support and horizontal on each side of the support connection.

14. The compensation system according to claim 1, wherein the loop member extends horizontally away from the pipe axis.

15. The compensation system according to claim 1, wherein the loop member extends vertically away from the pipe axis.

16. A compensation system for use with a pipe extending along a longitudinal axis and divided along its length to form a pair of open ends, the pipe being supported by at least one structure at first and second spaced apart points which points are subject to movement relative to one another, comprising:
a loop member attached to the pipe at the open ends and a support system for the loop member;
the loop member comprising:
a first and second connector end each configured to mate with one of the open ends of the divided pipe, and
a length of tubing extending between the first and second connector ends having at least one bend therein causing the tubing to extend away from the longitudinal axis of the pipe, the tubing being sufficiently flexible so as to accommodate a movement between the open ends of the pipe both axially and laterally, sufficient to relieve stress in the pipeline, the support system comprising:
a flexible support having a first end and a second end, the flexible support first end being secured relative to the at least one structure such that it will move with the first point and the flexible support second end being secured relative to the at least one structure such that it will move with the second point, when the first and second points move relative to one another, and
a support connection provided at the length of tubing for engagement by the flexible support between the two ends to permit movement of the tubing relative to the pipe, the support connection permitting movement of the flexible support relative to the support connection.

17. The compensation system according to claim 16, wherein the loop member comprises a single length of tubing extending from the first connector to the second connector.

18. The compensation system according to claim 16, wherein the loop member comprises multiple rigid sections with bends formed therein and multiple flexible sections between the first connector and the second connector.

19. A compensation system for use with a pipe extending along a longitudinal axis and divided along its length to form a pair of open ends, the pipe being supported at first and second spaced apart points, which points are subject to movement relative to one another, comprising:
a loop member attached to the pipe at the open ends and a support system for the loop member;
the loop member comprising:
a first and second connector end each configured to mate with one of the open ends of the divided pipe,
a length of tubing extending between the first and second connector ends having at least one bend therein causing the tubing to extend away from the longitudinal axis of the pipe, the tubing being sufficiently flexible so as to accommodate a movement between the open ends of the pipe both axially and laterally, sufficient to relieve stress in the pipeline,
the support system comprising:
a flexible support having a first end and a second end, the flexible support first end being secured relative to the first point such that it will move with the first point and the flexible support second end being secured relative to the second point such that it will move with the second point, when the first and second points move relative to one another, and
a support connection provided at the length of tubing for engagement by the flexible support between the two ends to permit movement of the tubing relative to the pipe, the support connection permitting movement of the flexible support relative to the tubing.
